(19) United States
(12) Patent Application Publication
(10) Pub. No.: US 2018/0107796 A1
(43) Pub. Date: Apr. 19, 2018

(54) SYSTEM AND METHOD OF PREDICTING AND ANALYZING UNDIAGNOSED MEDICAL CONDITIONS

(71) Applicants: 81QD, LLC, New York, NY (US); ATOMO, INC., Austin, TX (US)

(72) Inventors: Leon Behar, Scarsdale, NY (US); Kelly Myers, Austin, TX (US); Seth Myers, San Francisco, CA (US)

(21) Appl. No.: 15/297,679

(22) Filed: Oct. 19, 2016

(51) Int. Cl. G06F 19/00; G06N 99/00

(52) U.S. Cl. CPC G06F 19/324; G06N 99/005; G06F 19/3437; G06F 19/345

(57) ABSTRACT

A computerized system and method for analyzing encounter data representing encounters between patients and health care providers to predict whether one or more of the patients may have an undiagnosed condition. This prediction can be made by a machine learning algorithm that determines a probability that an undiagnosed condition may be present for encounters. The system identifies health care providers of patients that may have an undiagnosed condition. In some embodiments, the identification of health care providers could be plotted geographically on a map. In some cases, the system may provide an interface element that allows the user to filter health care providers that are identified by adjusting a probability threshold for those health care providers that are identified.

### TECHNICAL FIELD

This disclosure relates generally to computer systems and methods for detecting possible undiagnosed medical conditions; in particular, this disclosure relates to a computerized system and method in which encounter data between health care providers and patients are analyzed to predict those patients with undiagnosed conditions; in some embodiments, an interface is provided that allows a user to geographically plot those health care providers with patients possibly having an undiagnosed condition on a map.

### BACKGROUND AND SUMMARY

In the medical field, there are certain diseases and conditions that are difficult to diagnose. In some cases, the patient presents symptoms that are difficult to piece together as a diagnosis. In another situations, patient exhibits symptoms can be easy to misdiagnose as the wrong disease. These situations lead to a circumstance in which patients can be misdiagnosed with the wrong disease or simply go undiagnosed. In either case, this can lead to disastrous consequences for the patient if there is not a proper diagnosis until a point in which the disease has progressed.

This disclosure relates to a computerized system and method for analyzing encounter data representing encounters between patients and health care providers to predict whether one or more of the patients may have an undiagnosed condition. This prediction can be made by a machine learning algorithm that determines a probability that an undiagnosed condition may be present for encounters. The system identifies health care providers of patients that may have an undiagnosed condition. For example, this would allow these health care providers to be contacted so additional tests can be performed on their patients to determine whether the possible undiagnosed condition actually exists. In some embodiments, the identification of health care providers could be plotted geographically on a map. In some cases, the system may provide an interface element that allows the user to filter health care providers that are identified by adjusting a probability threshold for those health care providers that are identified.

According to one aspect, this disclosure provides an apparatus with a storage device and at least one processor coupled to the storage device. The storage device stores a program for controlling the at least one processor and causes the processor to obtain encounter data representative of a plurality of encounters between a plurality of patients and health care providers. The processor analyzes the encounter data to create a patient diagnosis model that includes predictions as to whether one or more of the encounters resulted in an undiagnosed medical condition of one or more patients. Typically, at least a portion of the predictions are represented as a probability of whether an undiagnosed medical condition exists. The processor applies a current probability threshold to filter a portion of the patient diagnosis model that has a probability greater than a current probability threshold. Data representative of the filtered patient diagnosis model that identifies health care providers of patients for which the probability of an undiagnosed medical condition exceeds the current probability threshold is transmitted by the processor. In some embodiments, the filtered patient diagnosis model identifies one or more of the health care provider's name, address, specialty, geographic latitude, and geographic longitude.

In some embodiments, the program is configured to cause the processor to plot the identified health care providers based on geographic location on a map. In some cases, at least a portion of the health care providers are represented on the map by a marker. For example, the marker could include a number representative of a number of patients for which the probability of having an undiagnosed medical condition exceeds the current probability threshold. In some embodiments, at least a portion of the health care providers are represented on the map by a cluster such that the cluster represents a plurality of health care providers that are in a similar geographic vicinity. In some cases, the cluster includes a number representative of a number of health care providers included in the cluster. Embodiments are contemplated in which the program is configured to cause the processor to adjust the current probability threshold responsive to user-selection of an interface element. For example, adjusting the current probability threshold could be used to dynamically adjust the map to identify only those health care providers with patients having encounters exceeding an adjusted probability threshold. Depending on the circumstances, a counter interface element could be provided that identifies a total number of patients represented on the map.

According to another aspect, this disclosure provides a computer-implemented method. The method includes the step of obtaining encounter data representative of a plurality of encounters between a plurality of patients and health care providers. The encounter data is analyzed to create a patient diagnosis model that includes predictions as to whether one or more of the encounters resulted in an undiagnosed medical condition of one or more patients. Typically, at least a portion of the predictions are represented as a probability of whether an undiagnosed medical condition exists. The method next applies a current probability threshold to filter a portion of the patient diagnosis model that has a probability greater than a current probability threshold. The data representative of the filtered patient diagnosis model that identifies health care providers of patients for which the probability of an undiagnosed medical condition exceeds the current probability threshold is then transmitted.

According to a further aspect, this disclosure provides a tangible, non-transitory computer readable medium storing instructions that, when executed by at least one processor, causes the at least one processor to perform a method in which encounter data representative of a plurality of encounters between a plurality of patients and health care providers is obtained. The encounter data is analyzed to create a patient diagnosis model that includes predictions as to whether one or more of the encounters resulted in an undiagnosed medical condition of one or more patients. In some cases, at least a portion of the predictions are represented as a probability of whether an undiagnosed medical condition exists. A current probability threshold is then applied to filter a portion of the patient diagnosis model that has a probability greater than a current probability threshold. Next, data representative of the filtered patient diagnosis model that identifies health care providers of patients for which the probability of an undiagnosed medical condition exceeds the current probability threshold is transmitted.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a diagrammatic view of an example computing device in which the undiagnosed patient analytics system could operate according to one embodiment;

FIG. 2 is a diagrammatic view of an example computing environment in which the undiagnosed patient analytics system could operate according to one embodiment;

FIG. 3 is a simplified block diagram showing an example diagnosis model interface according to one embodiment;

FIGS. 4-6 are screen shots of an example interface for the undiagnosed patient analytics system according to one embodiment; and

FIG. 7 is a flow chart showing example operations of the undiagnosed patient analytics system according to one embodiment.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

This disclosure relates generally to a computer system and method for predicting patients that may be undiagnosed with certain medical conditions. The system includes a machine learning algorithm that is configured to analyze data representing encounters between patients and health care providers to predict whether the patient has an undiagnosed condition. This analysis results in a patient diagnosis model that includes the predictions from the machine learning algorithm, along with other data related to the patients' health care providers. The system includes a patient diagnosis interface through which the user can review, analyze and filter the patient diagnosis model. In some embodiments, the patient diagnosis model can be plotted on a map that geographically shows various health care providers with patients possibly having undiagnosed conditions. The system includes various interface elements that allow a user to adjust various parameters, such as the threshold probability that is shown on the map, for the user to filter and analyze the data.

The detailed description which follows is presented in part in terms of algorithms and symbolic representations of operations on data bits within a computer memory representing alphanumeric characters or other information. An algorithm is provided by this disclosure and is generally conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. A method and apparatus are disclosed for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself, rather as a result of an instruction.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An apparatus is disclosed for performing these operations. This apparatus may be specifically constructed for the required purposes, or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

In the following description several terms which are used frequently have specialized meanings in the present context. The term “network” means two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. The term “browser” refers to a program which is not necessarily apparent to the user, but which is responsible for transmitting messages between the user's computer and the network server and for displaying and interacting with network resources.

Browsers are designed to utilize a communications protocol for transmission of text and graphic information over a worldwide network of computers, namely the “World Wide Web” or simply the “Web.” Examples of browsers compatible with the present invention include the Internet Explorer browser program offered by Microsoft Corporation (Internet Explorer is a trademark of Microsoft Corporation), the Chrome browser program offered by Google Inc. (Chrome is a trademark of Google Inc.), the Safari browser program offered by Apple Inc. (Safari is a trademark of Apple Inc.) or the Firefox browser program distributed by the Mozilla Foundation (Firefox is a registered trademark of the Mozilla Foundation). The browser could operate on a desktop operating system, such as Windows by Microsoft Corporation (Windows is a trademark of Microsoft Corporation) or OS X by Apple Inc. (OS X is a trademark of Apple Inc.). In some cases, the browser could operate on mobile operating systems, such as iOS by Apple Inc. (iOS is a trademark of Apple Inc.) or Android by Google Inc. (Android is a trademark of Google Inc.). Browsers display information which is formatted in a Standard Generalized Markup Language (“SGML”) or a Hyper Text Markup Language (“HTML”), both being scripting languages which embed non-visual codes in a text document through the use of special ASCII text codes. Files in these formats may be easily transmitted across computer networks, including global information networks like the Internet, and allow the browsers to display text, images, and play audio and video recordings.

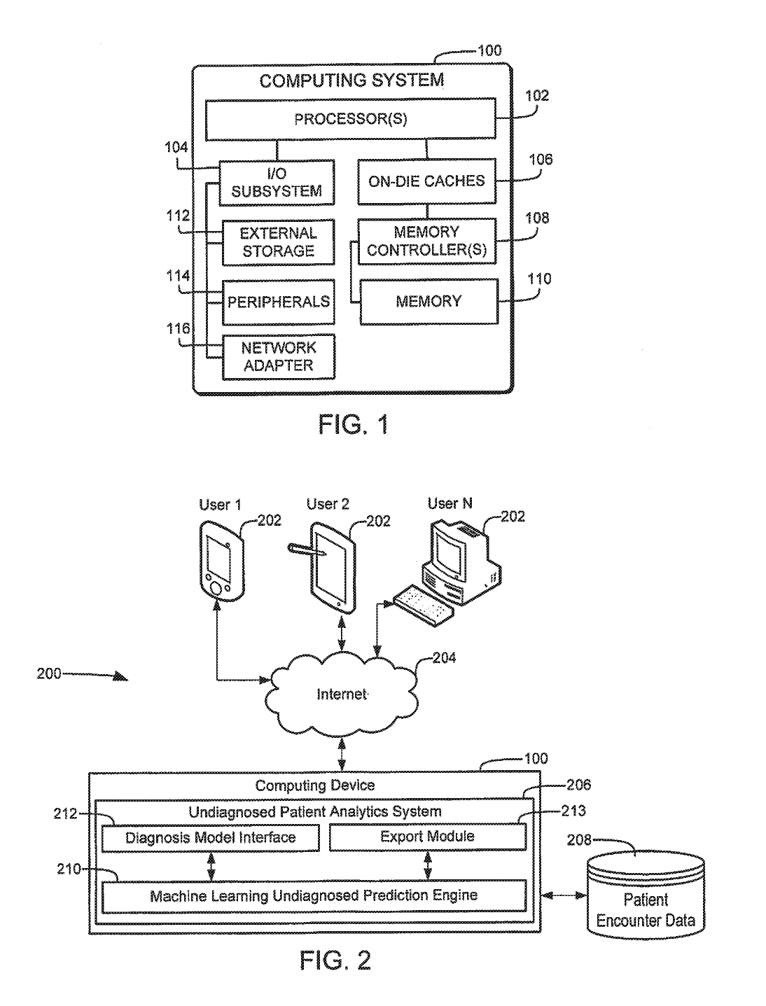

Referring now to FIG. 1, an illustrative computing device 100 for creating a model of patients with predictions as to possible undiagnosed conditions based on encounter data with health care providers, includes at least one processor 102, an I/O subsystem 104, at least one on-die cache 106, and a memory controller 108 to control a memory 110. The computing device 100 may be embodied as any type of device capable of performing the functions described herein. For example, the computing device 100 may be embodied as, without limitation, a computer, a workstation, a server computer, a laptop computer, a notebook computer, a tablet computer, a smartphone, a mobile computing device, a desktop computer, a distributed computing system, a multiprocessor system, a consumer electronic device, a smart appliance, and/or any other computing device capable of analyzing software code segments.

As shown in FIG. 1, the illustrative computing device 100 includes the processor 102, the I/O subsystem 104, the on-die cache 106, and the memory controller 108 to control a memory 110. Of course, the computing device 100 may include other or additional components, such as those commonly found in a workstation (e.g., various input/output devices), in other embodiments. For example, the computing device 100 may include an external storage 112, peripherals 114, and/or a network adapter 116. Additionally, in some embodiments, one or more of the illustrative components may be incorporated in, or otherwise form a portion of, another component. For example, the memory 110 or portions thereof, may be incorporated in the processor 102 in some embodiments.

The processor 102 may be embodied as any type of processor capable of performing the functions described herein. For example, the processor may be embodied as a single or multi-core processor(s), digital signal processor, microcontroller, or other processor or processing/controlling circuit. The memory 110 may be embodied as any type of volatile memory and/or persistent memory capable of performing the functions described herein. In operation, the memory 110 may store various data and software used during operation of the computing device 100 such as operating systems, applications, programs, libraries, and drivers. The memory 110 is communicatively coupled to the processor 102 via the memory bus using memory controller(s) 108, which may be embodied as circuitry and/or components to facilitate input/output operations with the processor 102, the memory 110, and other components of the computing device 100.

The I/O subsystem 104 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 104 may form a portion of a system-on-a-chip (SoC) and be incorporated, along with the processor 102, the memory 110, and other components of the computing device 100, on a single integrated circuit chip.

An external storage device 112 is coupled to the processor 102 with the I/O subsystem 104. The external storage device 112 may be embodied as any type of device or devices configured for short-term or long-term storage of data such as, for example, memory devices and circuits, memory cards, hard disk drives, solid-state drives, or other data storage devices.

The computing device 100 may include peripherals 114. The peripherals 114 may include any number of additional input/output devices, interface devices, and/or other peripheral devices. By way of example only, a peripheral may be a display that could be embodied as any type of display capable of displaying digital information such as a liquid crystal display (LCD), a light emitting diode (LED), a plasma display, a cathode ray tube (CRT), or other type of display device.

The computing device 100 illustratively includes a network adapter 116, which may be embodied as any communication circuit, device, or collection thereof, capable of enabling communications between the computing device 100 and other remote devices over a computer network (not shown). The network adapter 116 may be configured to use any one or more communication technology (e.g., wired or wireless communications) and associated protocols (e.g., Ethernet, Bluetooth®, Wi-Fi®, WiMAX, etc.) to effect such communication.

FIG. 2 is a high-level block diagram of a computing environment 200 under which the computing device 100 could operate according to one embodiment. FIG. 2 illustrates the computing device 100 and three clients 202 connected by a network 204. Only three clients 202 are shown in FIG. 2 in order to simplify and clarify the description. Likewise, a single computing device 100 is shown for purposes of simplicity, but multiple computing devices could be used. Embodiments of the computing environment 200 may have thousands or millions of clients 202 connected to the network 204, for example, the Internet. Users (not shown) may operate software, such as a browser, on clients 202 to both send and receive messages over network 204 via computing device 100 and its associated communications equipment and software (not shown). For example, the undiagnosed patient analytics system 206 could be accessed via computing device 100 using a browser. Typically, clients 202 would be able to access the undiagnosed patient analytics system 206 over the network 204 by entering a web address, such as an IP address, URL, or domain name (web address generally referred to as a “Destination”) into browser software. In some embodiments, clients 202 could include a dedicated application that connects with the undiagnosed patient analytics system 206 instead of using a web browser.

The example in FIG. 2 shows an example patient encounter database 208 to which the undiagnosed patient analytics system 206 has access. The patient encounter database 208 includes historical data relating to encounters between a plurality of patients and their respective health care providers. For example, the patient encounter database could include information regarding the patients' symptoms, information regarding tests performed on the patients, treatments and/or procedures performed on the patients, diagnosis of the patients, and other information regarding the medical care of the patient. In some embodiments, this information could be gleaned from submissions by a health care provider to an insurance company or other payor entity, such as a governmental agency, that includes information regarding encounters between health care providers and patients. This data may include, among other things, information regarding the health care provider and patient, along with one or more codes describing the encounter, such as Current Procedural Terminology (“CPT”) codes and International Classification of Disease (“ICD”) codes, and National Drug Codes (“NDC”), and/or physician referral information.

In the embodiment shown, the undiagnosed patient analytics system 206 includes a machine learning undiagnosed prediction engine 210. The machine learning undiagnosed prediction engine 210 is configured with a machine learning algorithm that learns to spot possible undiagnosed medical conditions based on a learning process using historical encounter data that includes undiagnosed medical conditions, which allows the algorithm to spot patterns that could be indicative of an undiagnosed condition. Based on this machine learning algorithm, the machine learning undiagnosed prediction engine 210 is able to predict whether encounters with patients in the patient encounter database 208 may be indicative of an undiagnosed condition. As a result, the machine learning misdiagnosis prediction engine 210 is able to create a patient diagnosis model that represents, among other thing, a prediction of whether one or more encounters with a patient resulted in an undiagnosed condition. For example, an encounter in which the machine learning undiagnosed prediction engine 210 predicts a low probability that an undiagnosed condition is present means that encounter likely resulted in a correct diagnosis. However, an encounter in which the machine learning undiagnosed prediction engine 210 predicts a high probability that the circumstances indicate an undiagnosed condition, means that the encounter with the patient likely resulted in an incorrect diagnosis. Techniques utilized to identify model feature include deep learning neural networks, autoencoding, and sparse feature selection. Machine learning techniques that are utilized by the algorithm include L1 regulated logistic regression, support vector machines, and random forest techniques.

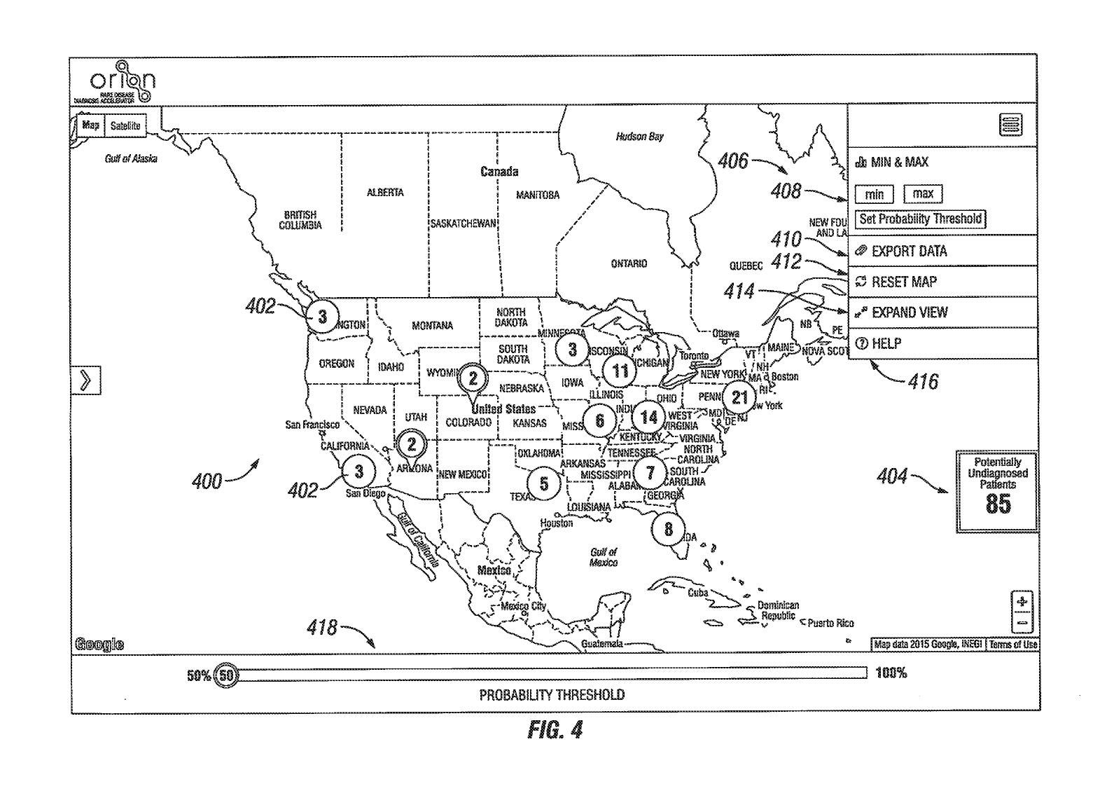

As shown, the undiagnosed patient analytics system 206 includes a diagnosis model interface 212 that is configured to allow a user to review and analyze the model created by the machine learning undiagnosed prediction engine 212 concerning the possible presence of an undiagnosed condition. With the diagnosis model interface 212, for example, a user can adjust certain parameters, such as the strength of the prediction, geographic region, health care provider, etc., when viewing the patient diagnosis model to perform analysis. This allows a user to pinpoint possible diagnosed conditions based on a variety of parameters. An example of the diagnosis model interface 212 is discussed below with respect to FIGS. 4-6.

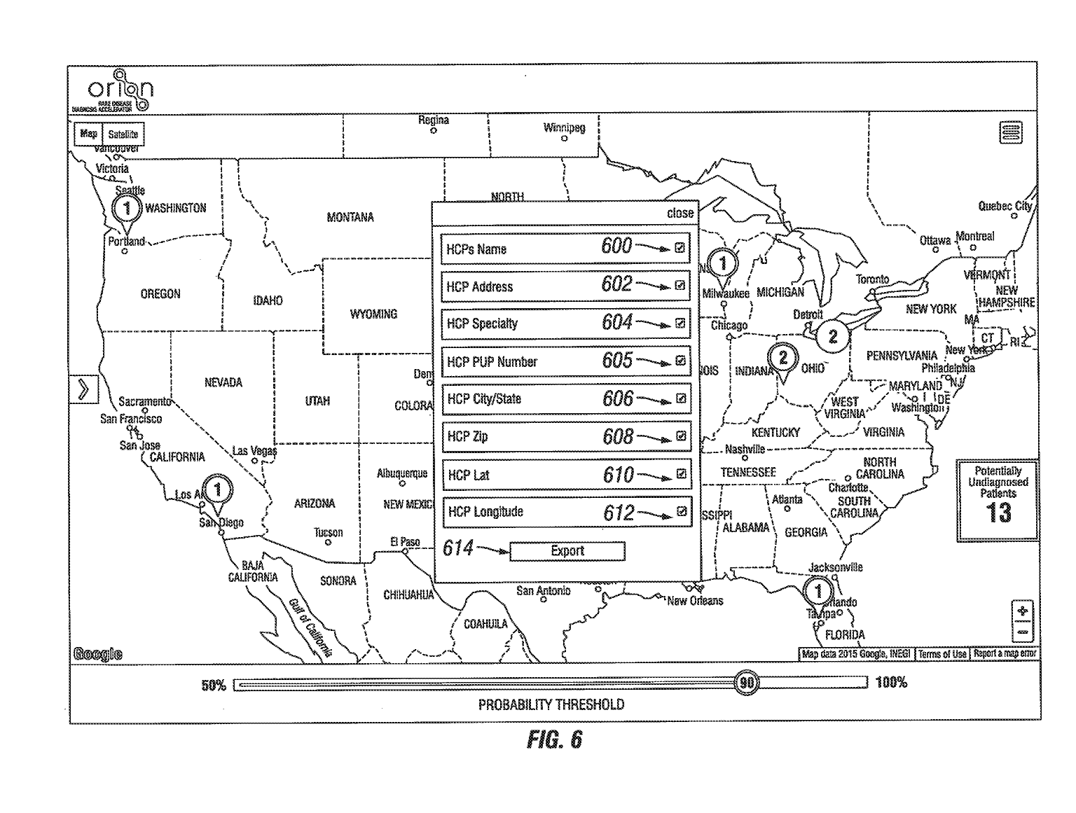

In the embodiment shown, the undiagnosed patient analytics system 206 includes an export module 213. The export module is configured to allow data from the patient diagnosis model to be exported in a variety of various data formats. In some cases, the user could focus the data using the diagnosis model interface 210 and export that focused portion of the patient diagnosis model using the export module 213. An example of an interface for exporting data is shown in FIG. 6.

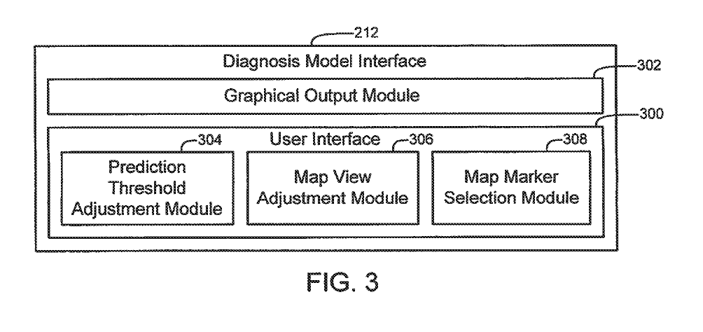

FIG. 3 is a block diagram showing modules that could be included in the diagnosis model interface 212. In the embodiment shown, the diagnosis model interface 212 includes a user interface 300 and a graphical output module 302. As shown, the graphical output module 302 is configured to visually display the patient diagnosis model in a graphical manner. For example, the patient diagnosis model could be graphically plotted on a geographic map based on a location of health care providers with patients possibly having an undiagnosed condition. This would allow the user to view the model in a graphical manner to visualize whether there are geographic areas on the map for which there are possible diagnosed conditions.

The user interface 300 provides interface elements by which the user can adjust parameters of the patient diagnosis model that are seen. This allows the user to focus on one or more parameters of interest. In the embodiment shown, the user interface 300 includes a prediction threshold adjustment module 304, a map view adjustment module 306, and a map marker selection module 308.

The prediction threshold adjustment module 304 allows the user to filter predictions from the patient diagnosis model. For example, the prediction threshold adjustment module 304 may be used to set the minimum and/or maximum prediction to be displayed to the user. In some cases, for example, the user may want to focus on situations in which there is a high probability that an undiagnosed condition is present. In those situations, the user would set the minimum prediction threshold to view a high number, such as 90 percent, to view only those situations in which there is a high probability of an undiagnosed condition. In some cases, the user may want to view a more complete universe of possible undiagnosed conditions. In such a situation, the user could set the minimum prediction threshold to a lower number, such as 50 percent.

The map view adjustment module 306 allows the user to adjust the geographic settings that are being viewed. For example, the map view adjustment module 306 could be used to filter the patient diagnosis module to select a particular geographic region. In some embodiments in which the patient diagnosis model is plotted on a map, the map view adjustment module 306 could adjust the view of the map by zooming in or zooming out, as well as moving the map location that is centered.

The map marker selection module 308 allows a user to select certain data of the patient diagnosis model to see additional information. In some embodiments in which the patient diagnosis model is plotted on a geographic map, for example, the areas in which there is a predicted probability greater than the current threshold could be plotted as markers or clusters on the map. In some cases, the user could select one of the markers to view additional information about the selected data, such as the health care provider(s) and related information represented by that marker.

FIGS. 4-6 are screen shots showing an example graphical user interface that could be used to review and analyze the patient diagnosis model. In the embodiment shown, the patient diagnosis model is plotted on a geographical map to show the geographic dispersion of possible undiagnosed conditions. In the example shown, a portion of North America is shown as a map 400 with a plurality of markers 402 indicating geographic areas in which there are patients in which a possible undiagnosed condition exists. As shown, the markers or clusters 402 have a numerical value indicative of the number of possible patients with undiagnosed conditions in that geographic area. In this example, there is an area with a total or counter 404 of undiagnosed patients for the map currently being shown. Although the patient diagnosis model shown in this example has 85 patients with possible undiagnosed conditions for the probability threshold selected, this is merely shown for purposes of example and the number of undiagnosed patients will vary based on the patient diagnosis model.

In the example shown, the interface includes a quick menu 406 that allows a user to customize the preference settings. As shown, the quick menu 406 includes a min and max portion 408 that allows a user to set minimum and maximum probability threshold settings for the logged in user. The system will save these settings for the next session. As shown, the quick menu 406 includes an export data portion 410 that allows the user to select columns, order columns, and choose the columns they need to be exported, such as into a CSV file, as shown in FIG. 6. In this example, the quick menu 406 includes a reset map portion 412 that will reinitialize all settings for the map being viewed. As shown, the quick menu 406 includes an expand view 414 that will remove the top and bottom borders and the map image will be displayed larger. The help portion 416 of the quick menu 406 will initiate the display of instructional help overlays. As shown in this embodiment, the interface includes a probability threshold adjustment portion 418, such as a slider as shown, which allows the user to adjust the probability threshold that is shown on the map.

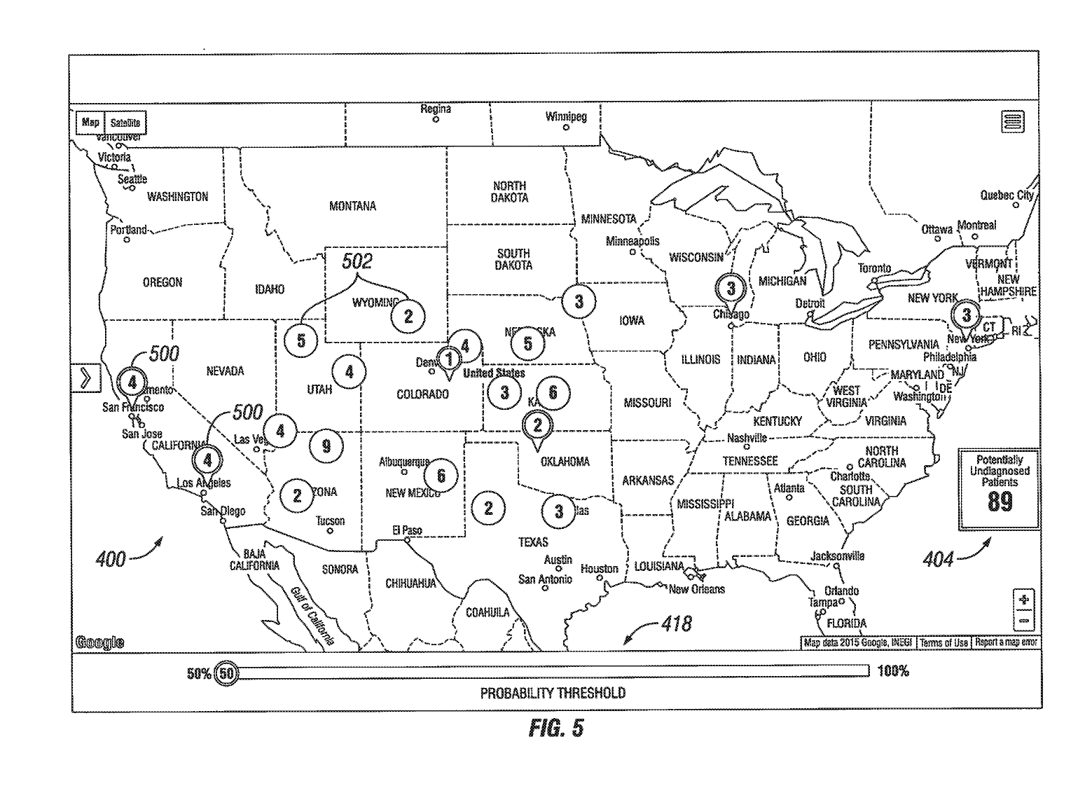

Referring to FIG. 5, there is shown an embodiment of the interface with a different example patient diagnosis model than that shown in FIG. 4. As explained above, the interface includes a probability threshold portion 418 that can be adjusted to filter certain patients that fall below the probability threshold. As shown, the left side of the probability threshold portion 418 indicates a lower probability while the right side of the probability threshold portion 418 indicates a higher probability. Accordingly, in this embodiment, a user moving the probability threshold portion 418 towards the left would cause the map to be dynamically updated to reveal additional markers and/or clusters that meet the lowered probability threshold. Conversely, a user that moves the probability threshold portion 418 towards the right would cause the map to dynamically update to reveal fewer markers and/or clusters that meet the heightened probability threshold. For example, as the probability threshold portion 418 moves further towards the right, the number of patients becomes more refined.

In some embodiments, the interface can includes both map markers 500 and map clusters 502 that indicate patients with possible undiagnosed conditions. The term “map marker” is intended to indicate a marker than when selected displays a geographic address of a health care provider that has one or more patients with a possible undiagnosed condition that meets the current probability threshold. The term “map cluster” is intended to indicate an area of the map with multiple health care providers having patients with possible undiagnosed conditions that are in the same place or proximity, but may not be the same geographic area.

FIG. 6 is a screen shot showing an example interface for selecting data to export, which could be shown upon selecting the export data portion 410 in the quick menu 406. As shown, the user can select which types of data for the export, along with an ordering of between data types. In the example shown, the user can select or unselect with a checkbox between the health care provider's name 600, address 602, specialty 604, PUP number 605, city and state 606, zip code 608, geographic latitude 610, and geographic longitude 612. If the user selects a type of data, that type of data will be exported for the geographic area and probability threshold selected. By unchecking certain types of data, the user can exclude those types of data from the export. In some cases, the sort order of the export could be changed. For example, the sort order could be changed by dragging the column indicators to create the desired order. Upon selecting which of the columns and order that is desired, the user would select the Export button 614 to export the data.

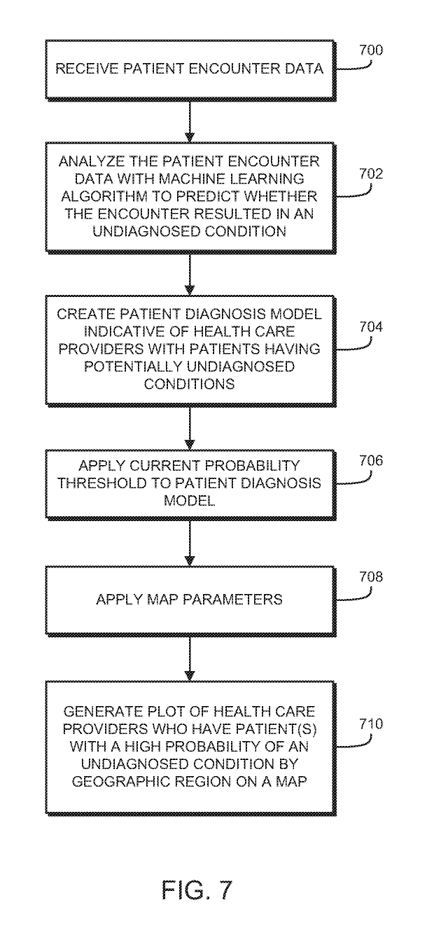

FIG. 7 is a flow chart showing possible operations that may be taken by the undiagnosed patient analytics system 206. In the embodiment shown, the system 206 starts at block 700 by receiving patient encounter data, such as from the patient encounter database 208. Next, at block 702, the system 206 analyzes the patient encounter data to predict whether the encounter resulted in an undiagnosed condition. The system 206 next, at block 704, creates a patient diagnosis model that indicates the health care providers that have patients with a potentially undiagnosed condition. The patient diagnosis model includes, in some embodiments, a probability of an undiagnosed condition, a health care provider of the patient, and related information about the health care provider. The system 206 then advances to block 706 in which the current probability threshold is applied to the patient diagnosis model. As discussed above, the probability threshold can be changed by the user to filter patients based on how likely it is that they are undiagnosed. Next, at block 708, the system applies the current map parameters based on the view of the map desired by the user. The system then, at block 710, generates a plot of health care providers on a map showing those that have a patient with a possible undiagnosed condition.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. An apparatus comprising:
a storage device; and
at least one processor coupled to the storage device, wherein the storage device stores a program for controlling the at least one processor, and wherein the at least one processor, being operative with the program, is configured to:
obtain encounter data representative of a plurality of encounters between a plurality of patients and health care providers;
analyze the encounter data to create a patient diagnosis model that includes predictions as to whether one or more of the encounters resulted in an undiagnosed medical condition of one or more patients, wherein at least a portion of the predictions are represented as a probability of whether an undiagnosed medical condition exists;
apply a current probability threshold to filter a portion of the patient diagnosis model that has a probability greater than a current probability threshold; and
transmit data representative of the filtered patient diagnosis model that identifies health care providers of patients for which the probability of an undiagnosed medical condition exceeds the current probability threshold.

2. The apparatus of claim 1, wherein the filtered patient diagnosis model identifies one or more of the health care provider's name, address, specialty, geographic latitude, and geographic longitude.

3. The apparatus of claim 1, wherein the program is configured to cause the processor to plot the identified health care providers based on geographic location on a map.

4. The apparatus of claim 3, wherein at least a portion of the health care providers are represented on the map by a marker.

5. The apparatus of claim 4, wherein the marker includes a number representative of a number of patients for which the probability of having an undiagnosed medical condition exceeds the current probability threshold.

6. The apparatus of claim 3, wherein at least a portion of the health care providers are represented on the map by a cluster, wherein the cluster represents a plurality of health care providers that are in a similar geographic vicinity.

7. The apparatus of claim 6, wherein the cluster includes a number representative of a number of health care providers included in the cluster.

8. The apparatus of claim 3, wherein the program is configured to cause the processor to adjust the current probability threshold responsive to user-selection of an interface element.

9. The apparatus of claim 8, wherein adjusting the current probability threshold dynamically adjusts the map to identify only those health care providers with patients having encounters exceeding an adjusted probability threshold.

10. The apparatus of claim 3, further comprising a counter interface element configured to identify a total number of patients represented on the map.

11. A computer-implemented method, comprising:
obtaining encounter data representative of a plurality of encounters between a plurality of patients and health care providers;
analyzing the encounter data to create a patient diagnosis model that includes predictions as to whether one or more of the encounters resulted in an undiagnosed medical condition of one or more patients, wherein at least a portion of the predictions are represented as a probability of whether an undiagnosed medical condition exists;
applying a current probability threshold to filter a portion of the patient diagnosis model that has a probability greater than a current probability threshold; and
transmitting data representative of the filtered patient diagnosis model that identifies health care providers of patients for which the probability of an undiagnosed medical condition exceeds the current probability threshold.

12. The method of claim 11, wherein the filtered patient diagnosis model identifies one or more of the health care provider's name, address, specialty, geographic latitude, and geographic longitude.

13. The method of claim 11, further comprising plotting the identified health care providers based on geographic location on a map.

14. The method of claim 13, wherein at least a portion of the health care providers are represented on the map by a marker.

15. The method of claim 14, wherein the marker includes a number representative of a number of patients for which the probability of having an undiagnosed medical condition exceeds the current probability threshold.

16. The method of claim 13, wherein at least a portion of the health care providers are represented on the map by a cluster, wherein the cluster represents a plurality of health care providers that are in a similar geographic vicinity.

17. The apparatus of claim 16, wherein the cluster includes a number representative of a number of health care providers included in the cluster.

18. The apparatus of claim 13, further comprising adjusting the current probability threshold responsive to user-selection of an interface element.

19. The apparatus of claim 18, wherein adjusting the current probability threshold dynamically adjusts the map to identify only those health care providers with patients having encounters exceeding an adjusted probability threshold.

20. The apparatus of claim 13, further comprising a counter interface element configured to identify a total number of patients represented on the map.

21. A tangible, non-transitory computer readable medium storing instructions that, when executed by at least one processor, causes the at least one processor to perform a method comprising:
obtaining encounter data representative of a plurality of encounters between a plurality of patients and health care providers;
analyzing the encounter data to create a patient diagnosis model that includes predictions as to whether one or more of the encounters resulted in an undiagnosed medical condition of one or more patients, wherein at least a portion of the predictions are represented as a probability of whether an undiagnosed medical condition exists;
applying a current probability threshold to filter a portion of the patient diagnosis model that has a probability greater than a current probability threshold; and
transmitting data representative of the filtered patient diagnosis model that identifies health care providers of patients for which the probability of an undiagnosed medical condition exceeds the current probability threshold.
